(19) United States
(12) Patent Application Publication
(10) Pub. No.: US 2012/0114996 A1
(43) Pub. Date: May 10, 2012

(54) BATTERY HOLDER, BATTERY ARRAY USING SAME

(76) Inventors: San-Chuan YU, Changhua County (TW); Sen-Tsai Chang, Changhua County (TW); Chih-Chang Huang, Taichung County (TW)

(21) Appl. No.: 12/939,584

(22) Filed: Nov. 4, 2010

(51) Int. Cl. H01M 2/10

(52) U.S. Cl. 429/99

(57) ABSTRACT

A battery array includes at least one battery holder, multiple battery cells and at least one electrode plate. The battery holder includes multiple block members and multiple clamps. Each block member has one sidewall thereof connected to one sidewall of another block member. Each clamp is fastened one sidewall of each of two adjacent block members to secure the two block members together. Each battery cell has its one end accommodated in one block member of the battery holder. The electrode plate is fastened to two adjacent battery cells to electrically connect the two battery cells. Thus, different number of block members can be used with a respective number of clamps to form different shapes of battery holders for assembling different battery arrays having different configurations or different electrical power. The invention relates also to the construction of the battery holder.

### BACKGROUND OF THE INVENTION

1. Field of the Invention

The present invention relates to rechargeable batteries and more particularly, to a battery holder for holding multiple battery cells to form a battery array. The invention relates also to a battery array using the battery holder.

2. Description of the Related Art

Battery is a power source intensively used in our daily life. More particularly, a rechargeable battery that allows charging and discharging repeatedly has the advantages of cost-saving and environmentally friendly characteristics. Further, a rechargeable battery can be used as power source means for an electrical car or hybrid vehicle to solve the problems of short supply of oil and air pollution.

A rechargeable battery structure is known using a holder member (battery box or battery holder) to hold a plurality of rechargeable battery cells and to connect the rechargeable battery cells in series or in parallel for providing the necessary electrical power to an electric equipment. Subject to the arrangement of the holder member, the rechargeable battery structure has a particular fixed shape facilitating installation in the desired place, and the battery cells will not be separated from one another during the use of the rechargeable battery structure. However, for making a rechargeable battery structure having a different electrical power, a different number of rechargeable battery cells shall be assembled with a different holder member. Further, a same number of rechargeable battery cells may be assembled with a different holder member to form a rechargeable battery structure having a different shape subject to the installation space available in the matting electric equipment. In consequence, different molds shall be used for making different holder members for use with different specifications of rechargeable battery cells to assemble different rechargeable battery structures. Thus, the rechargeable battery structure manufacturing cost is relatively increased.

### SUMMARY OF THE INVENTION

The present invention has been accomplished under the circumstances in view. It is the main object of the present invention to provide a battery holder and a battery array using the battery holder, which eliminates the drawbacks of the aforesaid conventional rechargeable battery structures.

To achieve this and other objects of the present invention, a battery holder comprises a plurality of block members and a plurality of clamps. Each block member has one sidewall thereof connected to one sidewall of another block member. Each clamp is fastened to two adjacent block members at one lateral side of the two connected sidewalls to secure the two block members together.

To achieve this and other objects of the present invention, a battery array comprises at least one battery holder, a plurality of battery cells, and at least one electrode plate. Each battery cell has one end thereof accommodated in the battery holder. Each electrode plate is fastened to each two adjacent battery cells to electrically connect the two battery cells.

A battery array having a different number of battery cells and a different battery cell connection arrangement provides a different electrical power to fit a different electric equipment for a different power requirement. Further, a different number of block members can be used with a respective number of clamps to assemble a battery holder having a different configuration for holding a different number of battery cells for making a different battery array subject to different requirements. In other words, block members made by means of one same mold can be used for assembling different combinations of battery holders for making battery arrays of different configurations or different electrical power.

Other and further features, benefits and advantages and the assembly and use of the present invention will be understood by reference to the following description in conjunction with the accompanying drawings, in which like reference signs denote like elements of structure. However, it is to be understood to any person having skill in the art that the embodiments of the invention are for explanation only but not intended for use as a limitation.

### BRIEF DESCRIPTION OF THE DRAWINGS

FIG. 1 is an elevational view of a battery array in accordance with a first embodiment of the present invention.

FIG. 2 is an exploded view of the battery array in accordance with the first embodiment of the present invention. FIG. 3 is an exploded view of one battery holder of the battery array in accordance with the first embodiment of the present invention.

FIG. 4 is a side view of one row of block members for battery holder for the battery array in accordance with the first embodiment of the present invention.

FIG. 5 is a sectional view taken along line 5-5 of FIG. 4.

FIG. 6 is an exploded view of a complete rechargeable battery based on the battery array in accordance with the first embodiment of the present invention.

FIG. 7 is an exploded view of a battery array in accordance with a second embodiment of the present invention.

FIG. 8 is an oblique elevational view of one block member for the battery array in accordance with the second embodiment of the present invention, illustrating the arrangement of the first accommodation portion.

FIG. 9 is an oblique elevational view of one block member for the battery array in accordance with the second embodiment of the present invention, illustrating the arrangement of the second accommodation portion.

### DETAILED DESCRIPTION OF THE INVENTION

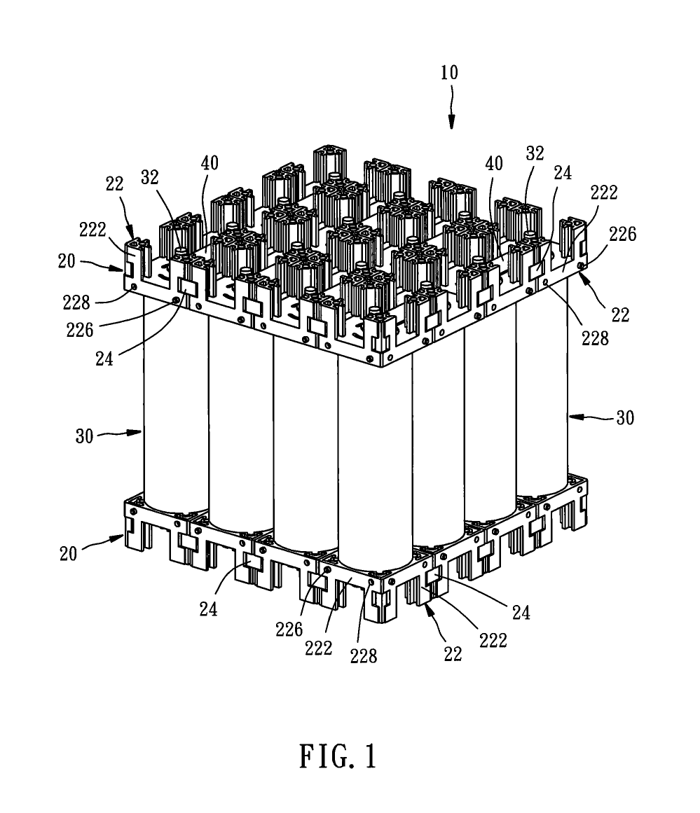

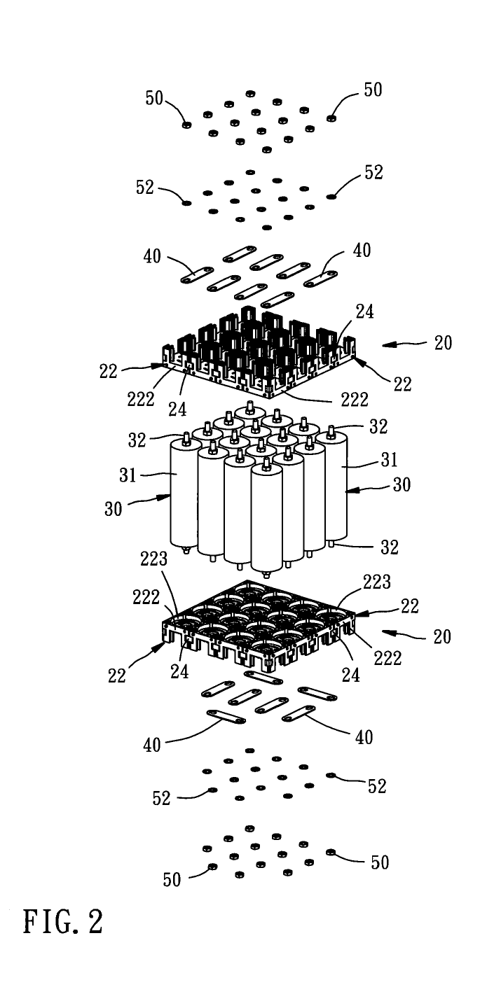

Referring to FIGS. 1 and 2, a battery array 10 in accordance with a first embodiment of the present invention is shown comprising two battery holders 20, a plurality of battery cells 30 and a plurality of electrode plates 40.

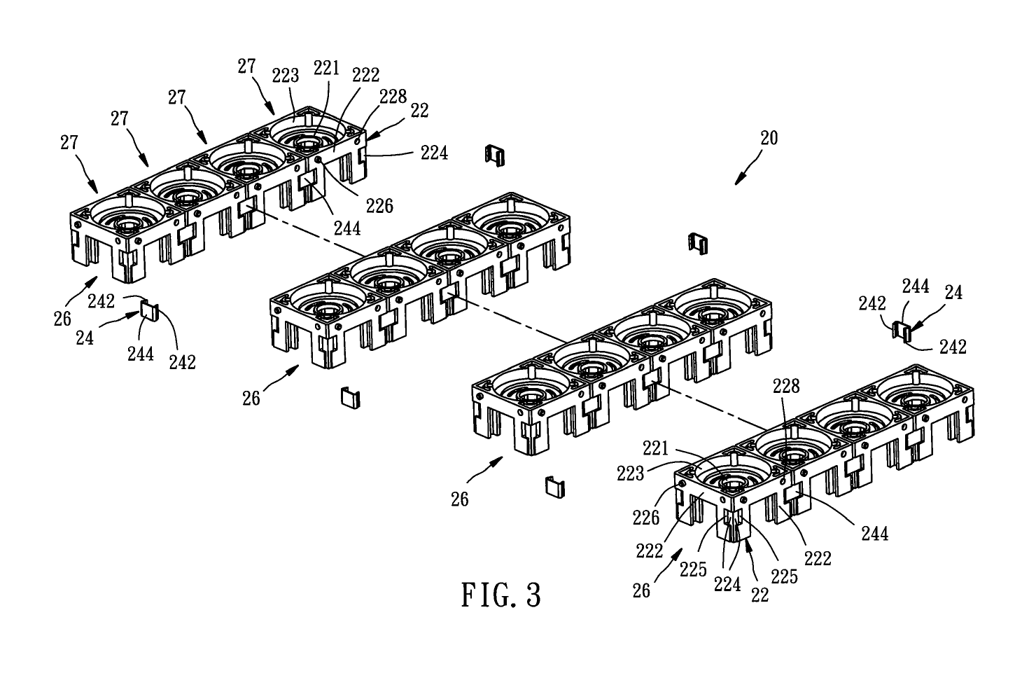

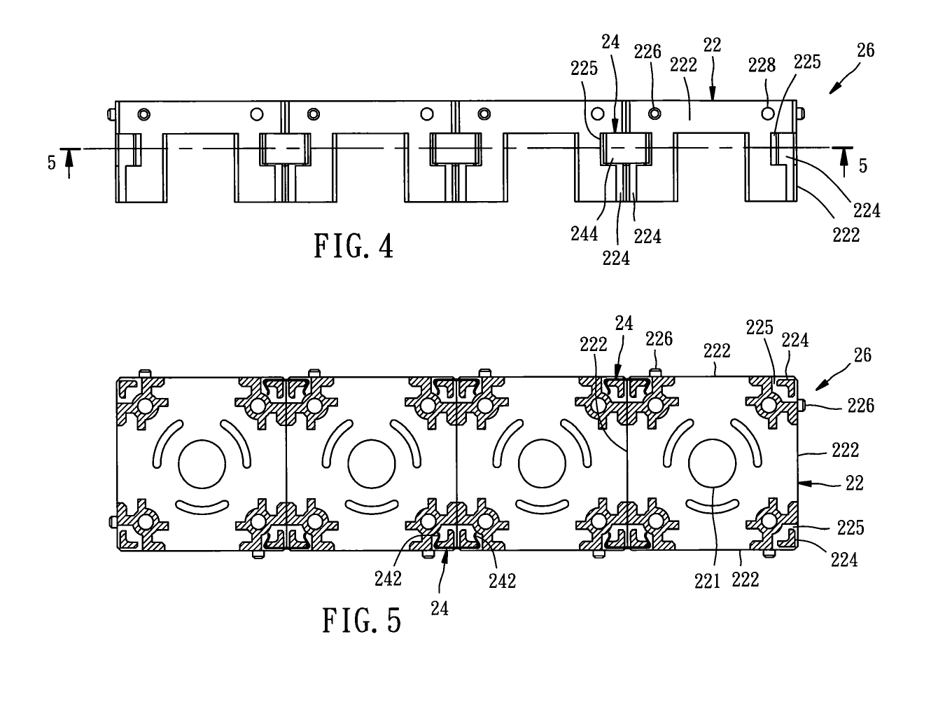

Referring also FIGS. 3-5, each battery holder 20 comprises a plurality of block members 22 and a plurality of clamps 24. Each block member 22 comprises a longitudinal through hole 221, four sidewalls 222 disposed in a parallel relationship relative to the longitudinal through hole 221 and an accommodation portion 223 connected to one end of the longitudinal through hole 221 in a circular shape. Each sidewall 222 comprises a recessed connection face 224 located on each of the left and right sides thereof, a retaining groove 225 located on each of the left and right sides and abutted against the associating recessed connection face 224, a retaining pin 226 disposed above the elevation of the recessed connection faces 224 near the left side and perpendicularly projecting toward the outside, and a pin hole 228 disposed above the elevation of the recessed connection faces 224 near the right side. The block members 22 are arranged into a rectangular array, forming multiple rows 26 and multiple lines 27.

Each block members 22 has its one sidewall 222 abutted against one sidewall 222 of one adjacent block member 22, and the retaining pin 226 and pin hole 228 at one of the two abutted sidewalls 222 are respectively forced into engagement with the pin hole 228 and retaining pin 226 at the other of the two abutted sidewalls 222, i.e., in the two abutted sidewalls 222 of each two adjacent block members 22, the retaining pin 226 at one sidewall 222 of each block member 22 is engaged into the pin hole 228 at one sidewall 222 of other block member 22.

Each clamp 24 comprises two clamping portions 242, and a connection portion 244 connected between the clamping portions 242. When assembling multiple block members 22 to form one battery holder 20, the block members 22 are connected into multiple rows 26 subject to the aforesaid connection procedure to engage the respective retaining pins 226 into the respective pin holes 228, and then fasten one clamp 24 to the two linked sidewalls 222 of each two adjacent block members 22 at each of two opposite lateral sides by forcing the connection portion 244 into the recessed connection faces 224 of the two linked sidewalls 222 and engaging the two clamping portions 242 into the respective retaining grooves 225, thus, the block members 22 of one same row 26 are secured firmly together and will not be forced apart from one another accidentally by an external force. Thereafter, fasten the block members 22 of different rows 26 together in the same manner to have the block members 22 be arranged in a rectangular array, forming multiple lines 27. Thereafter, fasten one clamp 24 to the two sidewalls 222 at one end of each two adjacent rows 26 to engage the two clamping portions 242 into the respective retaining grooves 225. Thus, each battery holder 20 is assembled, and the block members 22 of each battery holder 20 are firmly secured together and will not be forced apart from one another accidentally by an external force.

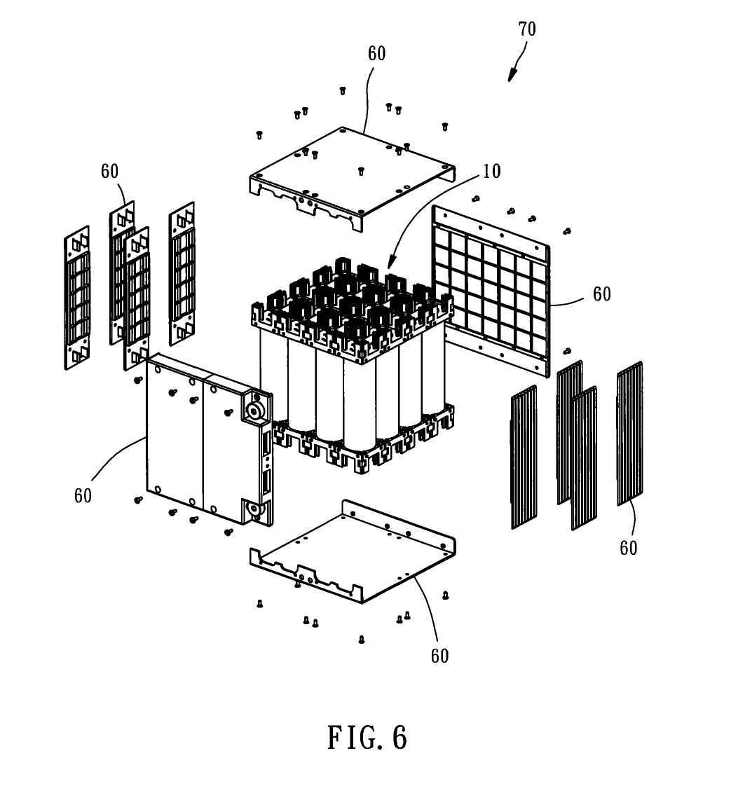

Referring to FIGS. 1 and 2, the battery cells 30 are commercial rechargeable battery cells, each comprising a cylindrical body 31 and two electrode terminals 32 respectively located on the two opposite ends of the cylindrical body 31. Each battery cell 30 has its one electrode terminal 32 inserted through the through hole 221 of one block member 22 of one battery holder 20, its other electrode terminal 32 inserted through the through hole 221 of one corresponding block member 22 of the other battery holder 20 and the two opposite ends of the cylindrical body 31 respectively accommodated in the accommodation portion 223 of the associating block member 22 of each of the two battery holders 20. The electrode plates 40 are respectively fastened to the electrode terminals 32 of each two adjacent battery cells 30 to electrically connect each two adjacent battery cells 30. By means of the connection of the electrode plates 40, the battery cells 30 are electrically connected, either directly or indirectly. The battery cells 30 and the electrode plates 40 are affixed to the block members 22 of the battery holders 20 by nuts 50 and washers 52, and thus the desired battery array 10 having a predetermined configuration and capable of outputting a predetermined electrical power is assembled. Further, multiple cover shells 60 can be mounted on the outside of the battery array 10 and fastened together (see FIG. 6), forming a complete rechargeable battery 70.

In the aforesaid battery array 10 in accordance with the present invention, the number of the battery cells 30 and their connection relationship can be adjusted subject to the electrical power required; the arrangement of the battery cells 30 can be changed subject to the desired configuration; different shapes of battery holders 20 can be assembled for preparing different battery arrays 10 by using block members 22 that are equal to the number of the battery cells 30 and a matting number of clamps 24. Thus, block members 22 made by means of one same mold can be used for assembling different combinations of battery holders 20 for making battery arrays 10 of different configurations or different electrical power. Thus, the cost of the rechargeable battery 70 is virtually minimized.

Further, it is to be understood that the method of using one clamp to fasten the two linked sidewalls at each of two opposite lateral sides of two adjacent block members is not a limitation. As an alternate form of the present invention, one clamp can be used to fasten the two linked sidewalls at one lateral side of two adjacent block members, and the two linked sidewalls at the other lateral side of two adjacent block members (the side opposite to the clamp) can be fastened together by a different fastening method or device.

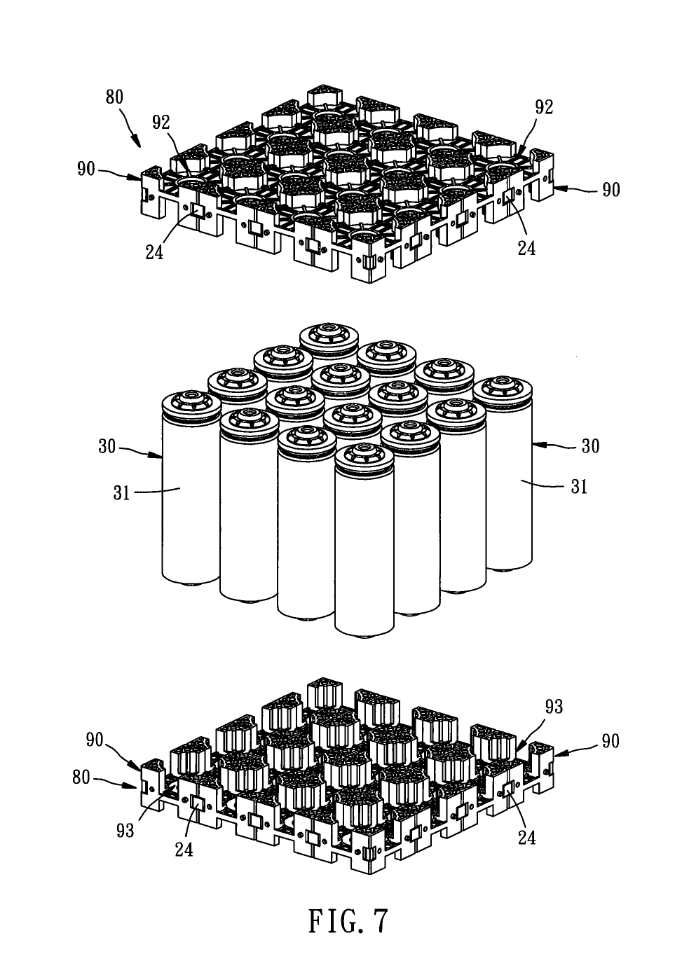

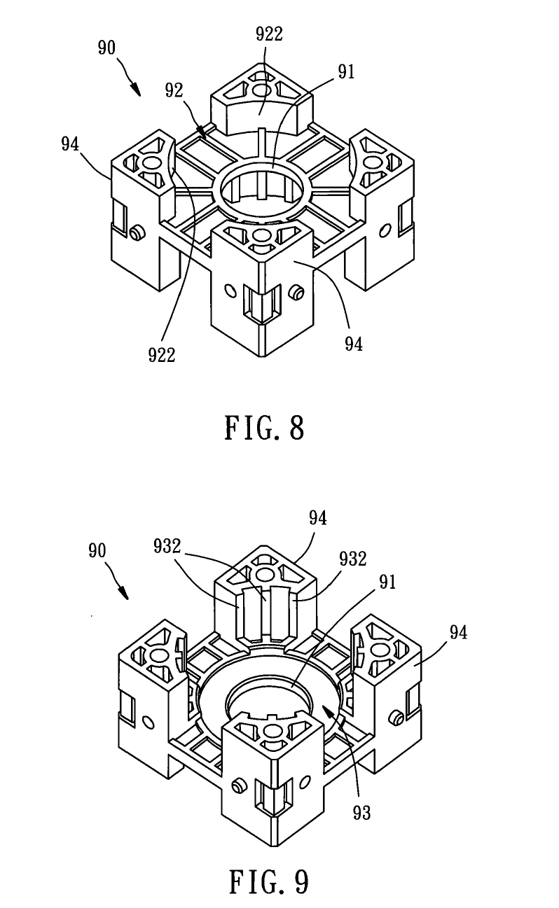

Referring to FIGS. 7-9, to fit a different specification of battery cells 30, battery holders 80 in accordance with a second embodiment of the present invention are used. Similar to the aforesaid first embodiment of the present invention, each battery holder 80 is assembled by using multiple block members 90 and multiple clamps 24. According to this second embodiment, each block member 90 comprises a first accommodation portion 92 and a second accommodation portion 93 respectively connected to the two distal ends of the longitudinal through hole 91 thereof. In detail, each block member 90 comprises four posts 94 respectively disposed in the four angles thereof and extending in direction corresponding to the two distal ends of the through hole 91. The posts 94 provide four arched wall surfaces 922 of one same radius of curvature for the first accommodation portion 92 so that the first accommodation portion 92 can be used to secure the body 31 of one battery cell 30 having the same radius of curvature. Further, each post 94 provides three arched wall surfaces 923 of one same radius of curvature for the second accommodation portion 93. The radius of curvature of the three arched wall surfaces 923 is smaller than the radius of curvature of the arched wall surfaces 922. The first accommodation portion 92 and the second accommodation portion 93 have different diameters for accommodating different sizes of battery cells 30.

Thus, as shown in FIG. 7, when assembling the two battery holders 80 with battery cells 30 of size fitting the second accommodation portions 93, the battery holders 80 are arranged in such a position that the second accommodation portions 93 of the block members 90 are kept facing the battery cells 30; when assembling the two battery holders 80 with battery cells 30 of size fitting the first accommodation portions 93, reverse the two battery holders 80 to let the first accommodation portions 93 face the battery cells 30.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A battery holder, comprising:
a plurality of block members, each said block member having one sidewall thereof connected to one sidewall of another said block member, each said block member comprising a first accommodation portion for accommodating one end of one battery cell; and
a plurality of clamps respectively fastened to each two adjacent block members at one lateral side of the two connected sidewalls of each two adjacent block members to secure the respective two adjacent block members together.

2. The battery holder as claimed in claim 1, wherein said each block member comprising a retaining groove; each said clamp comprising two clamping portions respectively engaged into the retaining groove of each two adjacent block members.

3. The battery holder as claimed in claim 1, wherein one of each two adjacent block members comprises at least one retaining pin protruded from one sidewall thereof and engaged into the other of said each two adjacent block member.

4. The battery holder as claimed in claim 1, wherein each said block member comprises a retaining pin and a pin hole located on one sidewall thereof, the retaining pin of one said block member being engaged into the pin hole of another said block member.

5. The battery holder as claimed in claim 1, wherein each said block member has four sidewalls, and said block members are arranged into a rectangular array, forming multiple rows and multiple lines; wherein two said clamps are respectively fastened to each two adjacent block members of one same row at two opposite sides; wherein one said clamp is fastened to block members at one end of each of two said rows.

6. The battery holder as claimed in claim 1, wherein each said block member comprises a through hole connected to and in communication with the first accommodation portion thereof and extending in a parallel relationship relative to the sidewall thereof.

7. The battery holder as claimed in claim 6, wherein each said block member further comprises a second accommodation portion connected to and disposed in communication with the through hole thereof opposite to the first accommodation portion thereof for accommodating one end of one battery cell.

8. The battery holder as claimed in claim 7, wherein the first accommodation portion and second accommodation portion of each said block member have different diameters for accommodating different sizes of battery cells. 20

9. A battery array using at least one battery holder as claimed in either of claim 1, comprising:
a plurality of battery cells, each said battery cell having one end thereof accommodated in the first accommodation portion of one said block member of said battery holder; and
at least one electrode plate fastened to each two adjacent battery cells to electrically connect the two battery cells.

10. The battery array as claimed in claim 9, which comprises two said battery holders, wherein the two ends of each said battery cell are respectively accommodated in said two battery holders.
